(19) United States
(12) Patent Application Publication
(10) Pub. No.: US 2006/0211567 A1
(43) Pub. Date: Sep. 21, 2006

(54) Method and slip for production of a moulded body from ceramic material ceramic moulded body and use of such a moulded body

(76) Inventors: Martina Kuhn, Lemwerder (DE); Stephan Dierkes, Bremen (DE); Dietmar Koch, Bremen (DE); Lars Andresen, Kappein (DE); Georg Grathwohl, Bremen (DE)

Correspondence Address: SCHIFF HARDIN, LLP;PATENT DEPARTMENT, 6600 SEARS TOWER, CHICAGO, IL, 60606-6473, US

(21) Appl. No.: 10/550,664

(22) PCT Filed: Jul. 30, 2004
(86) PCT No.: PCT/DE04/01756

§ 371 Date: Sep. 26, 2005

(30) Foreign Application Priority Data
Jul. 30, 2003 (DE) 103-35-224.4

(51) Int. Cl. C04B 35/14; B28B 1/00; B32B 9/00; C04B 35/16

(52) U.S. Cl. 501/133; 428/701; 428/698; 264/621

(57) ABSTRACT

In a method of making a ceramic shaped body which permits an adjustable volume change (shrinkage, zero shrinkage or increase in volume) compared to its green product, a metal oxide powder and a metal powder are stirred in a colloidal sol into slip and that slip is then consolidated in a mold into a green product by freeze-gelling and finally the green product is sintered in an active atmosphere which enables the metal powder to oxidize, to form the shaped body. The disclosure is also concerned with a slip for a shaped body of this kind and advantageous uses for the shaped body.

### BACKGROUND

The present disclosure relates to a method of making a shaped body out of ceramic material and a slip for making such a shaped body. In addition, the present disclosure relates to a ceramic shaped body and the use of such a ceramic shaped body.

In principle, two methods are known for making sintered ceramic shaped bodies.

First of all, it is known to press powder into the desired shape and to sinter the pressed green product so obtained in order to make the ceramic product. One disadvantage is that only limited shapes are possible. In addition, the green product shrinks during the sintering process. For this reason, a method is disclosed in EP 0 413 456 B1 according to which the ceramic powder containing silicon carbide (SiC) is suspended in ethanol, ground finer if necessary, and sifted. Afterwards, the ethanol is expelled and the powder so obtained is pressed into a green product and subsequently sintered under an oxygen atmosphere. The silicon carbide oxidizes into silicon oxide (SiO₂) in the process and counteracts the shrinkage.

Secondly, it is known to make a slip from ceramic powder. In the process, the ceramic powder is suspended in a solvent, usually water, together with a polymeric binder. The slip is poured into a mold and then consolidated, in the course of which a sol-gel transition occurs and a solid body forms. This body can be removed from the mold without changing its shape. The body is dried, and the actual green product forms in the process, shrinking sharply as it does so. In order to reduce dry shrinkage during drying, it is freeze-dried, supercritically (under pressure) or dried under a vacuum. The freeze-drying is often carried out under a simultaneous vacuum. The green product can then be sintered, in the course of which the binder escapes. One advantage of this process, which is known as gel-casting, is that very complex shapes can be formed. A disadvantage, however, is that the sintered shaped body shrinks considerably compared to the cast and green product.

Experiments have been carried out in order to minimize the shrinkage in ceramics cast from a slip. From EP 1 122 227 A2, for example, it is known to add silicon or a mixture of aluminum and aluminum oxide to the slip. After consolidation and freeze-drying, the green product obtained in this way is sintered under an oxygen atmosphere. The dimensional stability is still unsatisfactory with this process.

### SUMMARY

It is an object to provide a method of making ceramic shaped bodies which uses the advantages of gel-casting in order to be able to model complex shapes as well, and in which a controlled volume change is possible at the same time, while avoiding the complex drying processes of gel-casting. Another problem is to provide a slip and a shaped body of this kind. Finally, advantageous uses should be derived for ceramic shaped bodies produced in this way.

To solve this problem, a metal oxide powder and a metal powder are stirred in a colloidal sol into a slip and the slip is then consolidated in a mold into a green product by freeze-gelling. Finally the green product is sintered in an active atmosphere which enables the metal powder to oxidize to form the shaped body.

### BRIEF DESCRIPTION OF THE DRAWINGS

FIG. 1 shows a flow chart of a method of making a ceramic shaped body of the preferred embodiment;

FIG. 2 shows a device for freeze-gelling a slip in a schematic representation;

FIG. 3 shows a scanning electron microscope image of a shaped body made by the method of the preferred embodiment;

FIG. 4 shows a diagram of the shrinkage of ceramic materials made by the gel-casting process plotted against the sintering temperature compared to shaped bodies produced by the method of the preferred embodiment; and

FIG. 5 shows a possible application for a ceramic shaped body of the preferred embodiment.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

A central feature of the is that the slip manages without a binder. The gel-like green product arises solely as a result of the consolidation of the slip after it is poured into the mold. Specifically, the slip is cooled down in the mold in the process to a temperature lower than the freezing point of the solvent for consolidation purposes, which may be described as freeze-gelling. What is surprising about this is that, even after the solvent has been thawed, the body retains its shape without changing its contours. The green product is now dried. Since the green product already has a solid shape, this can be done under normal conditions or, in order to accelerate the drying process, at an elevated temperature. The green product retains the contours of its shape while drying. Complex drying methods, such as with gel-casting as described above, are not necessary. The green product is sintered under an atmosphere which enables the metal powder to oxidize preferably an oxygen atmosphere. Because of the open porosity of the green product, the oxidizing agent, i.e. preferably the oxygen, penetrates into the green product, so that the metal powder oxidizes. According to the method of the preferred embodiment, something takes place which might be described as reaction sintering. The preferred embodiment is based on the finding that shrinkage can be reduced first by avoiding the use of the binder. Secondly, shrinkage is compensated by the oxidation of the metal powder. In this context, by selecting the appropriate quantity of powder, the degree of shrinkage can be adjusted to a desired amount, which also includes zero shrinkage, or even an over compensation. Furthermore, it has been found that the ceramic obtained in this way exhibits improved mechanical properties compared to classic gel-casting. Even the green product possesses enhanced strength.

In order to improve the mechanical properties still further, especially tensile strength and impact value, a reinforcement of ceramic fibers, such as oxide, carbide and/or nitride fibers, can be added to the slip. In order to obtain a thermally or electrically conductive ceramic, a conductive material, such as silicon carbide, can also be added to the slip. Finally the slip can also be doped with carbon or carbon fibers. The carbon is burned completely during sintering, leaving behind deliberately introduced pores and/or channels in the shaped body.

Furthermore, in accordance with a further embodiment of the invention, the surface characteristics of the ceramic shaped body can also be influenced during the production process. It is, for example, possible subsequently to infiltrate a substance into the green product which determines the surface characteristics of the later shaped body. Silanes, siloxanes, sols, a metal melt, a glass melt and/or a slip are conceivable here. Alternatively the substance can also be subsequently infiltrated into the finished ceramic.

In order to solve the problem, the slip of the preferred embodiment is comprised of a mixture of metal oxide powder and metal powder suspended in a colloidal sol. This slip can be sintered according to the method described above. Suitable sols are in particular silicon dioxide sol (silica sol), aluminum oxide sol, aluminum hydroxide sol (boehmite) and/or zirconium oxide sol. These ought to be present in the form of a nanosol. Suitable metal oxides are in particular silicon, aluminum, zirconium, titanium, calcium, magnesium oxide and/or mullite and/or spinel. For the metal powder, it is possible to use precious, semi-precious or base metals and, alternatively, alloys of these metals or intermetallic alloys.

A ceramic shaped body which solves the problem on which the preferred embodiment is based is produced by reaction-sintering, under an oxidizing atmosphere, a green product made from a freeze-gelled slip prepared from a mixture of metal powders and metal oxide powder suspended in a colloidal sol.

Thanks to a very precise mold accuracy and contour retention, a ceramic shaped body of this kind can preferably be used advantageously in aerospace engineering, microsystems engineering, refractory engineering and/or casting, and especially in casting molds. The ceramic shaped body of the preferred embodiment is particularly advantageous for metal casting. It is, for example, possible in this way to produce a master pattern on a precise 1:1 scale and then to take a mould of it with the slip of the preferred embodiment. In the process, a precise amount of metal powder is added to the slip to ensure that the increase in volume during sintering corresponds exactly to the shrinkage of the later cast metal body. As a casting mold, therefore, the ceramic shaped body is then bigger to precisely the extent of the shrinkage of the metal casting. The preferred embodiment can therefore be used particularly well for high-precision casting (high-precision molding).

A further use can be found in the field of chromatography. It is known to use charges of ceramic powder in this field. From the above description it becomes clear that not only the degree of volume change (increase and decrease in volume and complete compensation), but also the porosity can be adjusted. This can be advantageously used to produce a monolithic ceramic shaped body with a reactive surface, such as for biotechnology, and especially for chromatography.

In addition, the preferred embodiment can be used very well in order to produce a composite component from a ceramic shaped body and a substrate. Ceramic components are very difficult to combine with other materials, such as metals. Thanks to the method of the preferred embodiment, it is now possible to adjust the degree of volume change during sintering by adding the corresponding amount of metal powder to the slip in such a way that the ceramic shaped body is press fitted with the substrate.

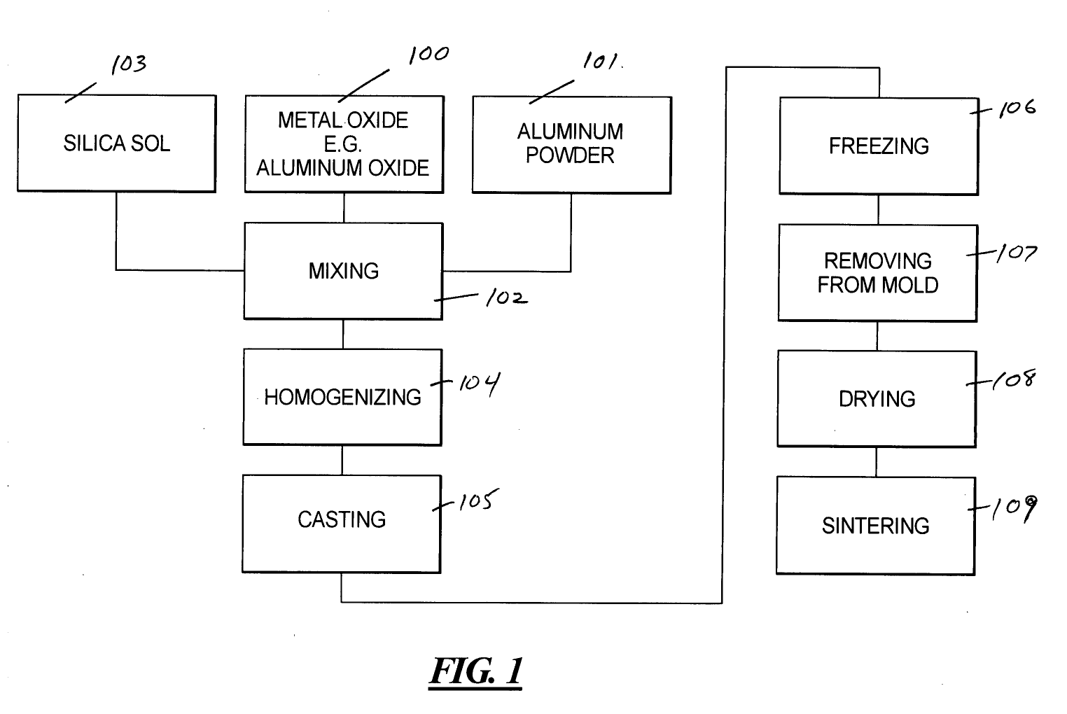

According to the method of the preferred embodiment as shown in FIG. 1, a metal oxide powder and a metal powder, such as aluminum oxide powder 100 and aluminum powder 101, are mixed at 102. This mixture is homogenized into a colloidal sol, in this case silica sol 103, and suspended into a slip. The slip is then poured into a negative mold for the later shaped body and cooled, with the mold (represented in FIG. 1 by homogenizing 104 and casting 105) to a temperature lower than the freezing point of the solvent, i.e. frozen at 106. The temperature here ought to be well below the freezing point. In the present case, the slip is cooled with the mold to between −5° C. and −40° C. As a result, the slip turns irreversibly into a solid gel (green product). This green product can now be removed from the mold at 107 and subsequently thawed.

The green product is dried at 108 under normal conditions or at an elevated temperature in an air kiln and sintered at 109 under an oxygen atmosphere. Because of the open porosity, the oxygen penetrates into the green product, and the metal powder oxidizes. The ceramic shaped body forms.

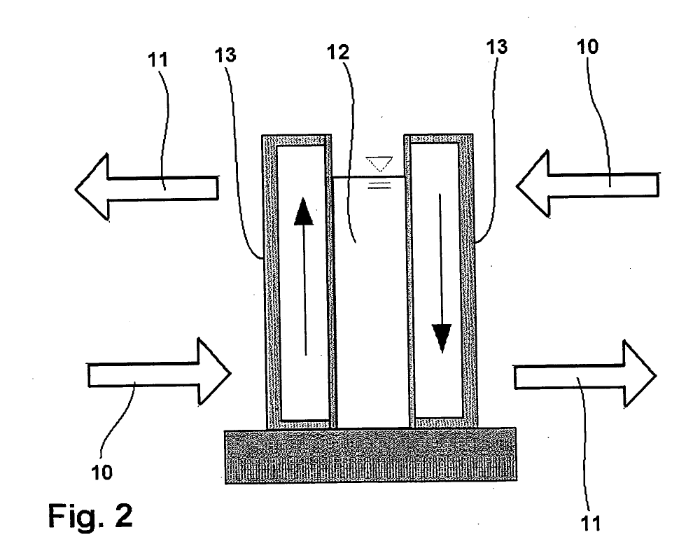

FIG. 2 shows a device in which the slip can be freeze-gelled. The device has coolant supply lines 10 and coolant drainage lines 11 indicated schematically as arrows. The slip 12, optionally with the mold, is placed in a cooling jacket 13, which may also be the mold for pouring off the slip 12 itself. The coolant causes the slip 12 to freeze and gel. A suitable coolant, if the slip is to be frozen to about −40° C., is ethanol. At lower temperatures, down to about −80° C., dry ice is suitable. At even lower temperatures, liquid nitrogen is used. The temperature has an influence on the size of the crystals of frozen solvent, in this case water from the sol, and thus on the pore size.

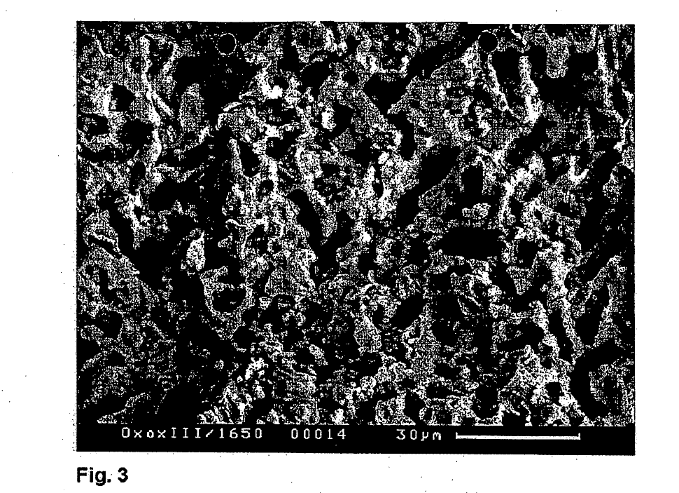

An image of a fracture surface of the ceramic shaped body taken with a scanning electron microscope is shown in FIG. 3. The ceramic material (light) and the pores (dark) can clearly be seen.

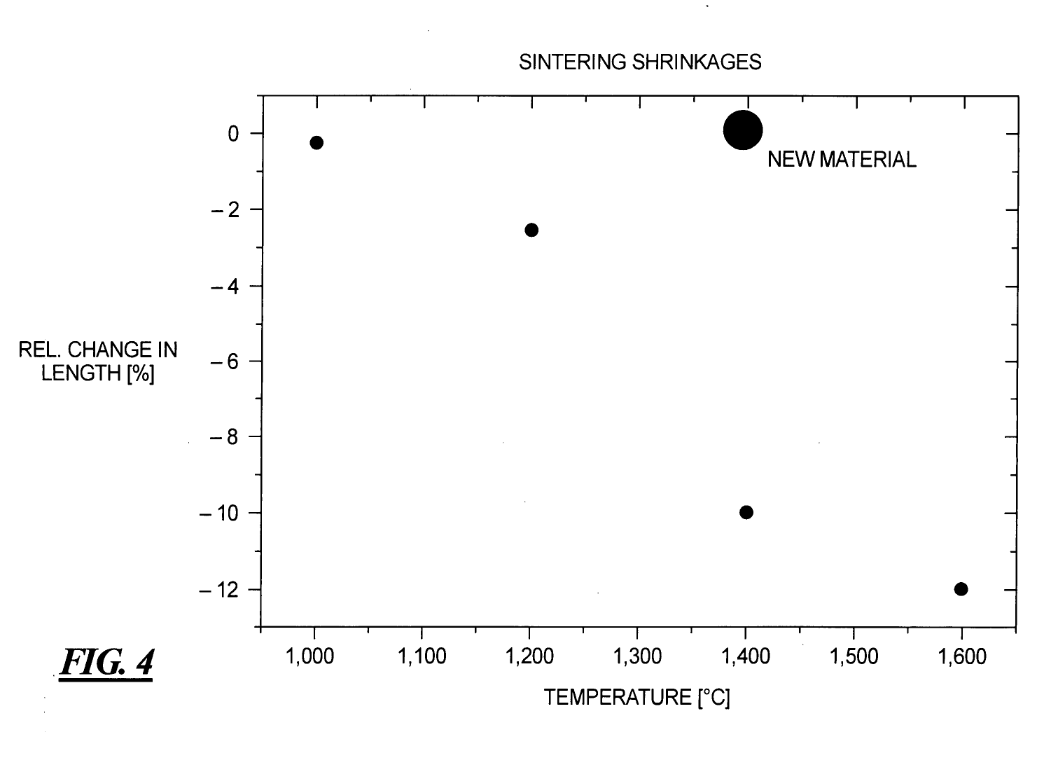

FIG. 4 shows a comparison between the ceramic material made by the method of the preferred embodiment and a material according to the state of the art. It can be seen that material according to the state of the art already undergoes slight shrinkage at 1,000° C. At 1,400° C., the shrinkage already amounts to about 10%, while the material produced in accordance with the preferred embodiment does not undergo any shrinkage.

According to a second embodiment, a metal oxide sol, such as a silicon sol (silica sol), is stirred into a homogeneous slip with a ceramic powder, such as mullite and/or aluminum oxide for example. Specifically, 50 parts by weight of aqueous silicon sol (40 wt.-% SiO₂ in 60 wt. % water) with a particle size of 14 nm and 100 parts by weight of ceramic powder are blended. In addition, there are 15 parts by weight of metal powder, namely aluminum powder or a powder of aluminum with 5% magnesium (AlMg5).

The slip is poured into a mold and freeze-gelled at −40° C. After removal from the mold, the green product is dried at about 70° C. and sintered under an oxygen atmosphere at at least 1,000° C., especially 1,400° C. In the process, the metal powder oxidizes.

If desired, it is also possible to add so much metal powder or so little oxygen that the metal does not oxidizes completely. Some metal powder then remains in the ceramic shaped body, so that the latter is thermally and electrically conductive. The same effect can be achieved if the green product is sintered at a lower temperature or if the reaction is interrupted by terminating the sintering process prematurely.

Thanks to the great freedom of design with respect to the mold a wide range of uses are possible. The ceramic shaped bodies may, for example, be used as casting molds, in refractory engineering or microsystems engineering.

By doping the slip with carbon, it is possible deliberately to introduce small channels in the shaped body, so that it may, for example, be used as a heat exchanger. The carbon burns off completely during sintering and leaves behind the channels or also deliberately introduced pores. The carbon forms a core, as it were, or even a large number of (microscopically) small cores.

It becomes clear from the above description that not only the degree of volume change (increase and decrease in volume and complete compensation), but also the porosity can be adjusted. This can advantageously be used for chromatography.

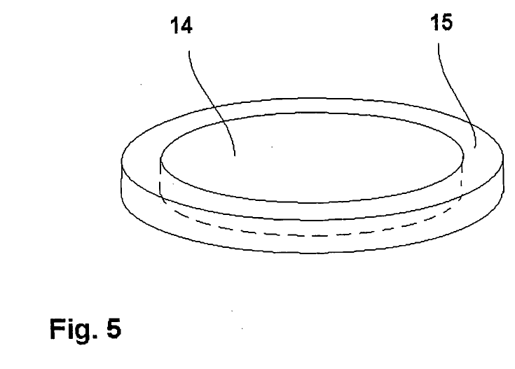

A further use of the preferred embodiment is shown in FIG. 5, in which a filter 14 made from of a ceramic produced in accordance with the preferred embodiment is pressed into a retaining ring 15. For this purpose, the slip, to which so much metal powder has been added that the green product increases in volume during sintering, is poured into the retaining ring 15 and freeze-gelled between two plate coolers by analogy with the device of FIG. 2. After thawing and drying, the green product is sintered in the retaining ring 15, in the process of which its volume increases in accordance with the amount of metal powder added. The ceramic filter 14 is pressed into the retaining ring in this way.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1-15. (canceled)

16. A method of making a shaped body out of ceramic material, comprising the steps of:
stirring a metal oxide powder and a metal powder in a colloidal sol into a slip and consolidating the slip in a mold into a green product by freeze-gelling; and
sintering the green product in an active atmosphere which enables the metal powder to oxidize to form the shaped body.

17. A method of claim 16 wherein the green product is sintered under an oxygen atmosphere.

18. A method of claim 16 wherein the slip is doped with a reinforcement.

19. A method of claim 18 wherein the reinforcement comprises a ceramic fiber or fibers comprising oxide, carbide, or nitride fibers.

20. A method of claim 16 wherein the slip is doped with a conductive material.

21. A method of claim 20 wherein the doped conductive material comprises silicon carbide.

22. A method of claim 16 wherein the slip is doped in a targeted manner with carbon or carbon fibers.

23. A method of claim 16 wherein a substance which determines surface characteristics of the later shaped body is infiltrated into the green product.

24. A method of claim 23 wherein said substance comprises silanes, siloxanes, sols, a metal melt, a glass melt, or a slip.

25. A method of claim 16 wherein a substance which determines surface characteristics of the later shaped body is infiltrated into the shaped body, and the shaped body is then fired again.

26. A method of claim 25 wherein said substance comprises silanes, siloxanes, sols, a metal melt, a glass melt, or a slip.

27. A ceramic shaped body of ceramic material manufactured by the steps of:
stirring a metal oxide powder and a metal powder in a colloidal sol into a slip and consolidating the slip in a mold into a green product by freeze-gelling; and
the green product being sintered in an active atmosphere which enables the metal powder to oxidize to form the shaped boy.

28. A method of using a shaped body of ceramic material where said shaped body is manufactured by the steps of stirring a metal oxide powder and a metal powder and a colloidal sol into a slip and consolidating the slip in a mold into a green product by freeze-gelling, and sintering the green product in an active atmosphere which enables the metal powder to oxidize to form the shaped body, said use comprising aerospace engineering, microsystems engineering, refractory engineering, biotechnology, or casting.

29. A method of claim 28 wherein the method of use comprises casting molds.

30. A method of claim 29 wherein the use in casting molds comprises high-precision molding.

31. A method of claim 28 wherein the use comprises a heat exchanger.

32. A method of claim 28 wherein the use is in biotechnology for chromatography.

33. A composite component, comprising:
a ceramic shaped body;
a substrate;
said ceramic shaped body being manufactured by the steps of storing a metal oxide powder and a metal powder in a colloidal sol into a slip and consolidating the slip in a mold into a green product by freeze-gelling, and sintering the green product in an active atmosphere which enables the metal powder to oxidize to form the shaped body; and
adding an amount of metal powder to the slip for the shaped body to cause a volume change during sintering which is employed for a press fit between the shaped body and the substrate.
